(19) United States
(12) Patent Application Publication
(10) Pub. No.: US 2004/0053203 A1
(43) Pub. Date: Mar. 18, 2004

(54) System and method for evaluating applicants

(76) Inventors: Alyssa Walters, Philadelphia, PA (US); Janice Plante, Newton, PA (US); Patrick Kyllonen, Lawrenceville, NJ (US); James Kaufman, Redlands, CA (US); Ann Gallagher, Princeton, NJ (US)

Correspondence Address: ALYSSA WALTERS, 1 LINCOLN AVENUE, LAMBERTVILLE, NJ, 08530, US

(21) Appl. No.: 10/244,072

(22) Filed: Sep. 16, 2002

(51) Int. Cl. G09B 3/00

(52) U.S. Cl. 434/350

(57) ABSTRACT

Evaluation instruments that may comprise a standardized letter of recommendation (SLR) are generated for various types of entities (e.g., business, education institutions, government, etc.). These evaluation instruments include content that solicits feedback from an evaluator for evaluating an applicant for the entity. For example, the entity may be evaluating applicants for a specific need (e.g., employment, promotion, admission, etc.). An evaluation instrument is completed by one or more evaluators. Feedback provided by evaluators is analyzed, and one or more scores are generated for each applicant. A report including the one or more scores and other information for selecting an applicant is generated and transmitted to the entity. The report may be used by the entity to select an applicant.

### FIELD OF THE INVENTION

The invention is related to evaluating applicants. More specifically, the invention is related to providing a system and methods for the quantitative and standardized evaluation of applicants for selection by an entity.

### BACKGROUND OF THE INVENTION

Many entities often rely on recommendations from people knowledgeable about an applicant to make selection decisions about the applicant. For example, the majority of admissions committees in institutions of higher education typically require up to three letters of recommendation per applicant. The letters of recommendation provide additional applicant information that is not available through the standardized admissions test scores and grade point average (GPA).

These letters of recommendation vary widely ranging from a set of open-ended questions designed to gather quantifiable information (such as comparing an applicant's performance to other applicants' performances) to questions that capture specific non-cognitive qualities that an applicant may have (such as persistence). However, the lack of standardization prevents entities from making meaningful comparisons. Furthermore, letters of recommendation often include vague and overly general language and focus on variables that are not deemed useful by the entities. This may lead to mistakes or misinterpretations about an applicant's knowledge, skills and/or abilities. As a result, the reliability and validity of current letters of recommendation are unknown, difficult to estimate and suspect.

### SUMMARY OF THE INVENTION

According to an embodiment of the invention, a method for evaluating an applicant for an entity comprises selecting an evaluation instrument for evaluating the applicant based on an entity type. The evaluation instrument is used to solicit feedback from at least one evaluator. The method further includes steps for receiving the evaluation instrument completed by the at least one evaluator, and evaluating the applicant based on evaluator feedback in the completed, evaluation instrument.

According to another embodiment of the invention, a system for evaluating an applicant comprises a host connected to a data storage device configured to store a plurality of evaluation instruments; an applicant client connected to the host, wherein the applicant client is configured to transmit a request to evaluate an applicant to the host. The system further comprises at least one evaluator client connected to the host, wherein the evaluator client is configured to receive an evaluation instrument from among the plurality of evaluation instruments from the host and transmit at least one completed, evaluation instrument to the host. The host is configured to generate a report evaluating the applicant based on analysis of information from a completed, evaluation instrument transmitted from the at least one evaluator client.

According to yet another embodiment of the invention, a method for generating an evaluation instrument for evaluating an applicant comprises identifying constructs for the evaluation instrument; generating content for the evaluation instrument based on the identified constructs; and generating the evaluation instrument including the content, wherein the content solicits quantifiable responses and open-ended feedback from an evaluator.

According to yet another embodiment of the invention, a method for evaluating an applicant comprises receiving at least one completed evaluation instrument having content for soliciting feedback to evaluate the applicant, wherein the completed evaluation instrument includes a plurality of quantifiable responses provided by an evaluator responding to the content in the evaluation instrument; and assigning at least one numeric evaluation value for evaluating the applicant based on the plurality of quantifiable responses.

Although preferred embodiments of the present invention are described below in detail, it is emphasized that this is for the purpose of illustrating and describing the invention, and should not be considered as necessarily limiting the invention, it being understood that many modifications can be made by those skilled in the art while still practicing the invention claimed herein.

### BRIEF DESCRIPTION OF THE DRAWINGS

The invention is illustrated by way of example and not limitation in the accompanying figures in which like numeral references refer to like elements, and wherein:

FIG. 1 is a flow diagram of a method for evaluating an applicant, according to an embodiment of the invention;

FIG. 2 is a flow diagram of a method for generating an evaluation instrument, according to an embodiment of the invention;

FIG. 3 is a flow diagram of a method for evaluating a completed evaluation instrument, according to an embodiment of the invention;

FIG. 4 illustrates a block diagram of a system, according to an embodiment of the invention;

FIG. 5 illustrates a data flow diagram for selecting an evaluation instrument, according to an embodiment of the invention;

FIG. 6 illustrates a data flow diagram for generating a report to evaluate an applicant, according to an embodiment of the invention;

FIG. 7 illustrates an evaluation instrument, according to an embodiment of the invention;

FIG. 8 illustrates an evaluation instrument, according to another embodiment of the invention;

FIG. 9 illustrates an evaluation instrument, according to yet another embodiment of the invention;

FIG. 10 illustrates an evaluation instrument, according to yet another embodiment of the invention;

FIG. 11 illustrates an evaluation instrument, according to yet another embodiment of the invention;

FIG. 12 illustrates a report for evaluating one or more applicants, according to an embodiment of the invention;

FIG. 13 illustrates a report for evaluating one or more applicants, according to another embodiment of the invention;

FIG. 14 illustrates a report for evaluating one or more applicants, according to yet another embodiment of the invention;

FIG. 15 illustrates a report for evaluating one or more applicants, according to yet another embodiment of the invention; and

FIG. 16 illustrates a report for evaluating one or more applicants, according to yet another embodiment of the invention.

### DETAILED DESCRIPTION OF THE INVENTION

Evaluation instruments that comprise a standardized letter of recommendation (SLR) are generated for various types of entities (e.g., business, education institutions, government, etc.). Entities may also include divisions of an entity (e.g., college department, division of a business, etc.). These, evaluation instruments include content that solicits feedback from an evaluator evaluating an applicant for the entity. For example, the entity may be evaluating applicants for a specific need (e.g., employment, promotion, admission, etc.). An evaluation instrument is completed by one or more evaluators. Feedback provided by the evaluators in the completed evaluation instruments is analyzed, and a report for selecting an applicant is generated and transmitted to the entity.

In one embodiment, the evaluation instrument may include a form having content, such as questions soliciting feedback from evaluators. The content includes quantifiable response options that prompt specific statements or numeric scores for evaluating applicant qualities to avoid vague generalizations and allow for the generation of data for applicant pools.

Quantifiable response options in evaluation instruments prompt specific statements about applicant qualities rather than allow for vague generalizations. Evaluators may be requested to provide specific, concrete examples for particularly high or low ratings, which results in highly specific information and may discourage use of extreme or cavalier ratings. Further, a confidence measure could accompany each rating to account for variability in evaluators' knowledge of an applicant.

Standardization reduces the variation among letter writers that currently exists in unrestricted letters of recommendation. Maintaining a standard language, set of concepts, and collection of response options removes much of the ambiguity and the need for subjective interpretation of evaluator intent. The SLR alleviates many of the limitations inherent in current letters of recommendation, while retaining the benefits of gathering important qualitative applicant information. The evaluation instruments may be standardized by entity type to reduce variation among evaluators and allow for meaningful comparisons across applicants. Open-ended feedback may also be provided by the evaluator in the evaluation instrument.

The content in the evaluation instrument may inquire about empirically-established constructs deemed important by the entity. Constructs are variables to be assessed by the evaluator and may include emotional stability, maturity, creativity, motivation, teamwork, integrity, persistence, perseverance, oral and written communications skills, independence, content knowledge, course mastery, the ability to overcome obstacles, conscientiousness, leadership, overall applicant fit with entity, etc. An evaluation instrument may be modified to specifications provided by the entity, including content associated with constructs requested by the entity.

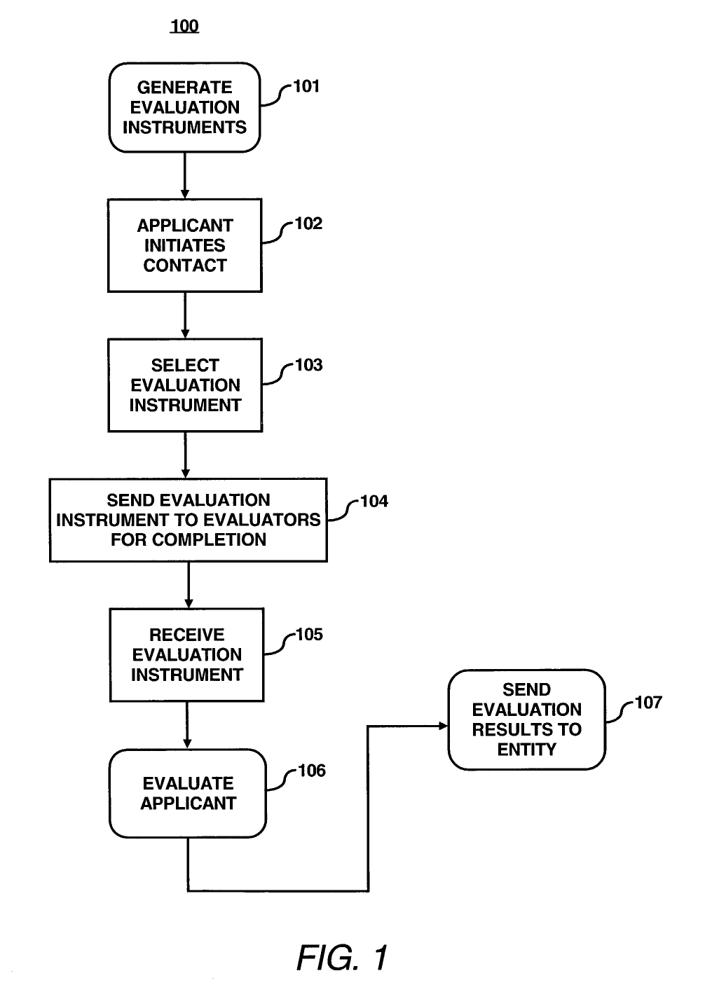

FIG. 1 is a flowchart of a method 100 for evaluating one or more applicants, according to an embodiment of the invention. At step 101, a plurality of evaluation instruments are generated. The plurality of evaluation instruments are customized for each entity type (e.g., business, education, government, etc.). For example, the evaluation instruments may include content that solicits feedback related to constructs specific to each entity type. Research may be conducted that identifies generic constructs uniform to a majority of entities of a specific type. These constructs may be the basis for content in an evaluation instrument. Also, these evaluation instruments may be further modified or customized based on specifications provided by a particular entity.

At step 102, an applicant initiates contact with the service electronically or physically (e.g., via the Internet, e-mail, telephone, mail, etc.). The initiated contact may include a request to be evaluated for a specific entity. The entity may be looking for one or more applicants to fill a specific need (e.g., employment, promotion, admission, etc.). The information in the applicant's request may include the entity's name, the need being applied for, applicant contact information, basic demographic information, and names and contact information for evaluators, etc. A record may be generated with this information as well as payment information, which may include a separate payment record.

At step 103, one or more evaluation instruments are selected for the entity. The selection may be based on the entity type. For example, a plurality of forms may be stored. One or more forms may be selected from the stored forms for the entity type associated with the entity selecting the applicant. Also, the selected evaluation instrument may be modified for the entity based on specifications provided by the entity.

At step 104, the selected evaluation instrument is sent to one or more evaluators recommending and/or evaluating the applicant. The evaluators are requested to complete the evaluation instrument for the applicant based on their knowledge of that applicant. Then, the evaluator sends the completed evaluation instrument back to the sender, which receives the completed evaluation instrument (step 105). Received evaluation instruments are processed to ascertain document completion. An applicant file may be generated for the entity. After all or a majority of evaluation instruments are received from the evaluators, the file may be marked as ready for processing.

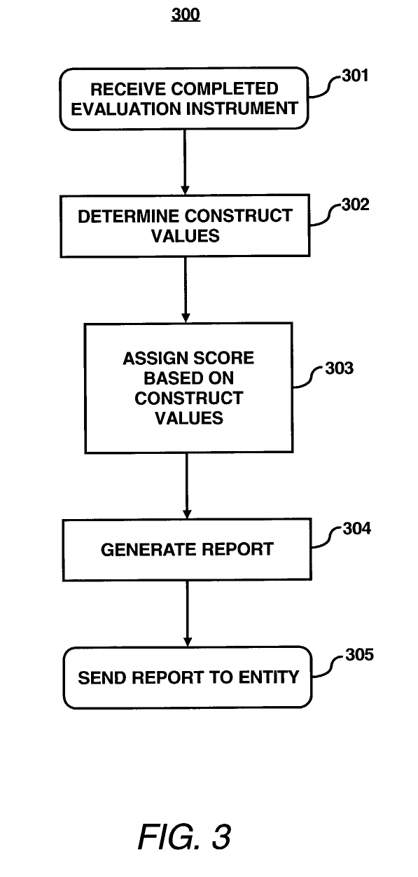

At step 106, evaluation results are generated from the applicant's data. At this step the applicant's data may be compiled and made ready for processing and analysis using the information from the completed evaluation instruments. The evaluation process provides summary cognitive and non-cognitive information (including emotional stability, motivation, persistence, team work, leadership, etc.) on an applicant for consideration by an entity for a predetermined situation. The feedback is analyzed, summarized, and quantified, as discussed in detail with respect to FIG. 3.

In one embodiment, the evaluation may include assigning one or more scores to the applicant based on the applicant's data. For example, the evaluation instrument may include quantifiable response options about a set of predetermined constructs and a summary of open-ended comments. An applicant may receive a construct value (e.g., a score for each construct) for each evaluated construct. A final evaluation score may be calculated based on the construct values which are determined based on the evaluator's selected response options and open-ended comments. Applicant rankings may be generated based on the comparison.

In another embodiment, a score with a summary of open-ended comments may be added to a score report. Evaluation techniques may also include aggregating numeric responses for each construct, averaging across raters, and /or weighting responses. One or more techniques may be used based on the entity's preferences or objectives.

At step 107, evaluation results from step 106 are sent to the entity. The evaluation results may also include predetermined evaluation materials for the applicant in an applicant package specific to the entity. The applicant package may be based on specifications provided by the entity.

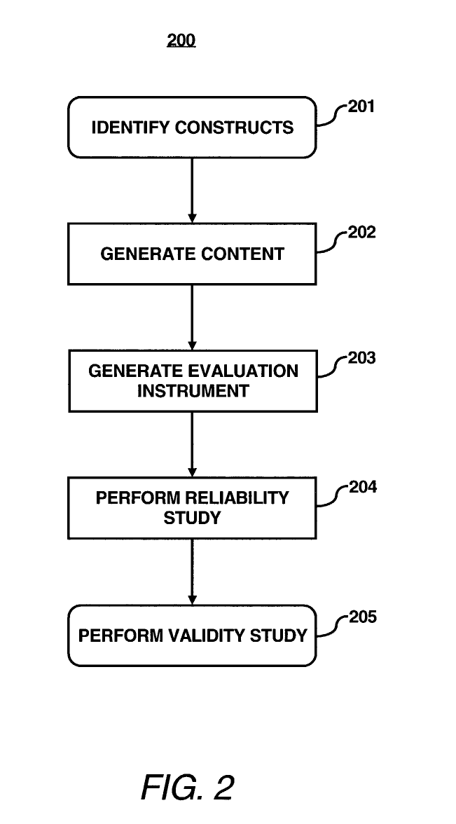

FIG. 2 illustrates a method 200, according to an embodiment of the invention, for generating an evaluation instrument. The method 200 includes steps that may be performed at steps 101 and 103 in the method 100 shown in FIG. 1. At step 201, constructs for an evaluation instrument are identified. The constructs include variables that are evaluated by an evaluator assessing an applicant for an entity.

If the evaluation instrument is generated for an entity type, research may be conducted that identifies generic constructs uniform to a majority of entities for the entity type. The evaluation instrument may also be customized based on specifications provided by a specific entity. For example, the entity may specify a specific format, identify questions, and select constructs to be evaluated through the evaluation instrument.

At step 202, content is generated based on the identified constructs. For example, questions are generated, which are associated with constructs to be evaluated. Content may solicit quantifiable responses and open-ended feedback from evaluators.

At step 203, an evaluation instrument is generated including the content. At step 204, a reliability study may be conducted to evaluate the reliability of the evaluation instrument. At step 205, a validity study may be conducted to evaluate the validity of the evaluation instrument. For example, the studies may include evaluating agreement between ratings of two recommendation providers rating a designated applicant; examining agreement between at least two recommendation receivers judging the feedback on a designated applicant; tracking a group of successful applicants for a predetermined period of time; and adding one or more constructs to the constructs obtained in the preliminary study and/or removing one or more constructs from the constructs obtained in the preliminary study.

It will be apparent to one of ordinary skill in the art that the steps in the method 200 may be repeated to generate a plurality of evaluation instruments. Evaluation instruments may be generated for multiple entity types and/or multiple entities.

FIG. 3 illustrates a method 300, according to an embodiment of the invention, for evaluating completed evaluation instruments. The method 300 includes steps that may be performed at step 106 of the method 100 shown in FIG. 1.

At step 301, a completed evaluation instrument is received. At step 302, a construct value is determined for each construct being evaluated. For example, an evaluator may provide a numeric rating for a construct value being evaluated in the evaluation instrument. Also, evaluator responses may be reviewed and assigned a construct value using a series of algorithms and statistical routines for example, averaging, weighted averaging, etc. Also, the construct values may be summed to generate the score depending on the entities' requirements.

At step 303, a score (e.g., a numeric evaluation value) is assigned for the applicant based on the construct values. The completed evaluation instrument may also include a confidence measure for one or more constructs being evaluated. The confidence measure is provided by the evaluator and is representative of the evaluator's confidence in his/her evaluation of a construct. The confidence measure may be used as one variable in the scoring algorithms to assign a score.

At step 304, a report is generated including, for example, the construct values and the score. The report is transmitted to the entity (step 305) by the mode specified by the entity (e.g., electronically, via mail, facsimile, etc,). The report may be customized based on specifications received from the entity. The report may include open-ended comments from evaluators, a summary of the feedback in the evaluation report, the score, etc. Also, the report may include an analysis of the applicant in comparison to at least one other applicant being evaluated for the same entity, the same entity type, and/or previous successful applicants that have been selected by the entity or for the entity type. The report may include graphics, such as tables, illustrating the comparison and rankings. The report may also include other information, such as contact information for the applicant and information about the evaluator.

As will be described in more detail below, many of the steps in the methods 100-300 illustrated in FIGS. 1-3 may be performed by a system 400 described in detail below. Additionally, the sequence of some of the steps shown in FIGS. 1-3 may be modified in accordance with the present invention.

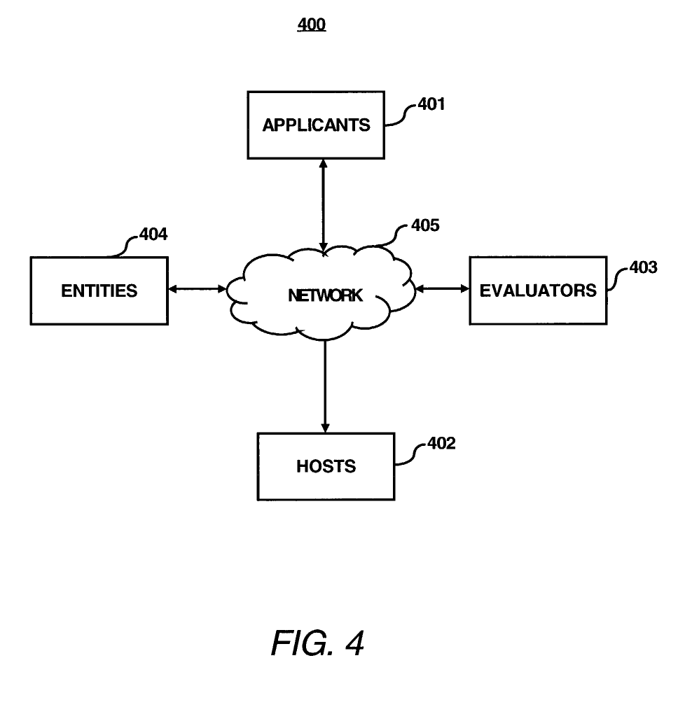

FIG. 4 is a block diagram of a system 400, according to an embodiment of the invention. The system 400 includes a host 402 for performing the steps in the methods 100-300 described with respect to FIGS. 1-3. The host 402 is connected to applicants 401, evaluators 403 and entities 404. In certain embodiments, the host 402 may be connected through one or more networks 405 to the applicants 401, evaluators 403 and entities 404. The networks 405 may include the Internet.

The host 402, applicants 401, evaluators 403 and entities 404 may use known computer platforms and may communicate with each other using network-enabled code. Network enabled code may be, include or interface to, for example, Hyper text Markup Language (HTML), Dynamic HTML, Extensible Markup Language (XML), Extensible Stylesheet Language (XSL) or other compilers, assemblers, interpreters or other computer languages or platforms.

In one embodiment, the system 400 includes a web-based, evaluation service. The service may be driven by entity profiles that populate content fields of an application form as well as an evaluation instrument. For example, one such entity profile may include a graduate school profile. Each school (e.g., an entity 404) may provide their school specific requirements to the host 402. The specifications may set up the appropriate forms for applicants to complete. For example, if a student is applying for a mathematics program, the non-cognitive attributes desired by that program might be different for an applicant applying to an English literature studies program. An applicant (e.g., an applicant 401) transmits applicant request information, including e-mail addresses for evaluators, to the host 402. The host 402 transmits e-mails to the evaluators (403) including a URL to access the evaluation forms. The evaluators 403 complete the form and send it to the host 402. The host 402 evaluates feedback from the completed forms and generates a report for the entity 404 (e.g., an admissions committee). Applicant ratings may be provided in the report.

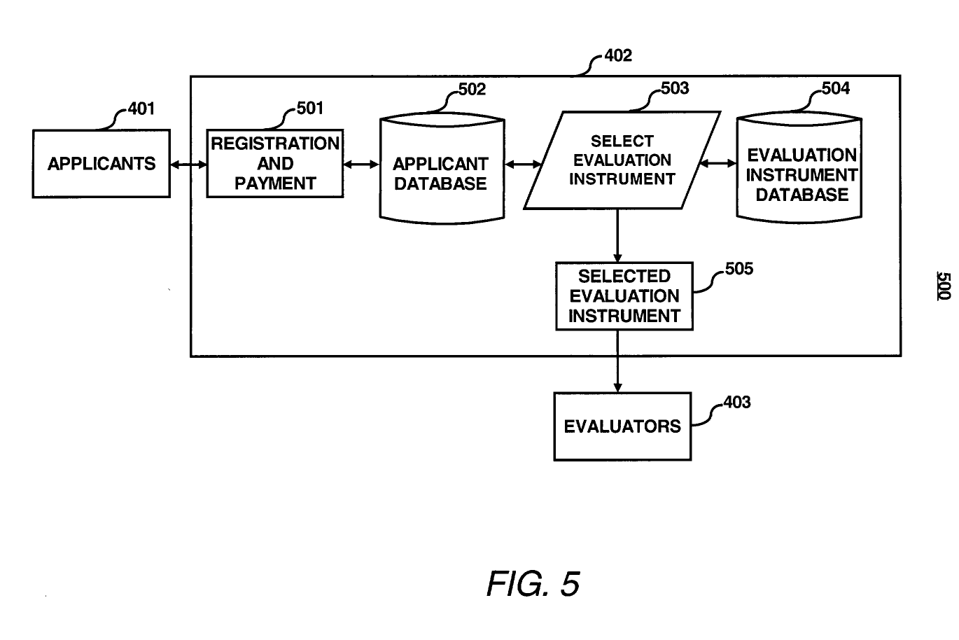

FIG. 5 is a data-flow diagram, according to an embodiment of the invention, illustrating the host 402 receiving information and selecting evaluation instrument(s). The host 402 receives evaluation request information from an applicant 401. The request information may include registration information (e.g., applicant contact information, evaluator information, entity name/ID, etc.) and payment 501. The host 402 generates an applicant record in an applicant database 502 with the request information. The host 402 selects one or more evaluation instruments (process 503) from an evaluation instrument database 504 based on the request information. The evaluation instrument may include a form customized for an entity type for an entity 404 or customized specifically for the entity 404. Selected evaluation instruments in 505 are sent to the evaluators 403.

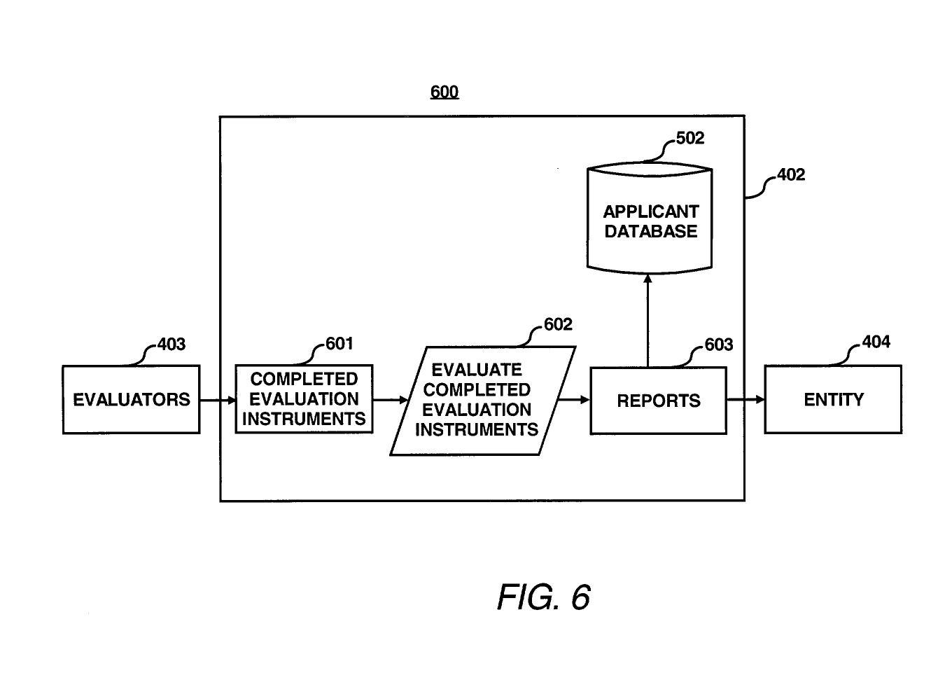

FIG. 6 is a data-flow diagram, according to an embodiment of the invention, illustrating the host 402 evaluating completed evaluation instruments and generating reports.

The host 402 receives completed evaluation instruments 601 from the evaluators 403. The host 402 receives the completed evaluation instruments 601. The host 402 reviews the evaluation instruments 601 for completeness, and responses are linked to the appropriate applicant file in the applicant database 502. When substantially all the evaluators' information is provided, the evaluation instruments 601 are analyzed and scored in 602. Based on the entities' desired reporting format, the appropriate algorithms and statistical analysis routines are applied to the applicant data from the evaluation instruments 601, and a score is produced (602). The data for an applicant pool may then be aggregated on single applicant reports or applicant group reports as defined by the entity. These reports 603 are delivered to the entity 404 based on their requirements. Some reports may be generated for the applicant 401 and transmitted thereto. Reports may be stored in the applicant database 502.

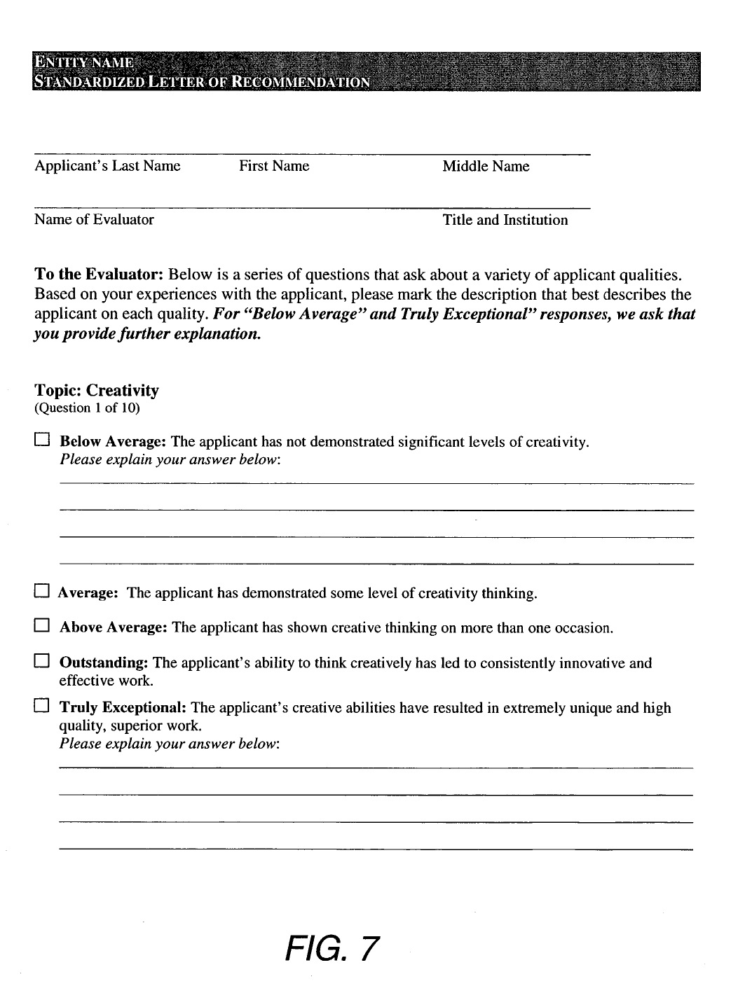

FIGS. 7-11 illustrate embodiments of evaluation instruments that may be used in the invention. FIGS. 7-11 illustrate evaluation instruments comprised of forms, however, evaluation instruments may be provided in other known formats and may be combinations of forms. FIG. 7 is an example of an embodiment of an applicant rating form that uses a behaviorally-anchored format. The rating form includes a range of descriptions regarding an applicant's level of a construct. The evaluator marks the box that corresponds to his or her assessment of the applicant. For example, the evaluator may indicate that the applicant's level of the construct is “below average,” “average,” “above average,” “outstanding,” or “truly exceptional.” For “below average” or “truly exceptional” responses, the evaluator is required to provide an open-ended explanation for the rating. This embodiment would include items that would inquire about additional constructs. Construct values may be assigned based on ratings provided in the form or ratings provided in forms shown in any of FIGS. 7-11.

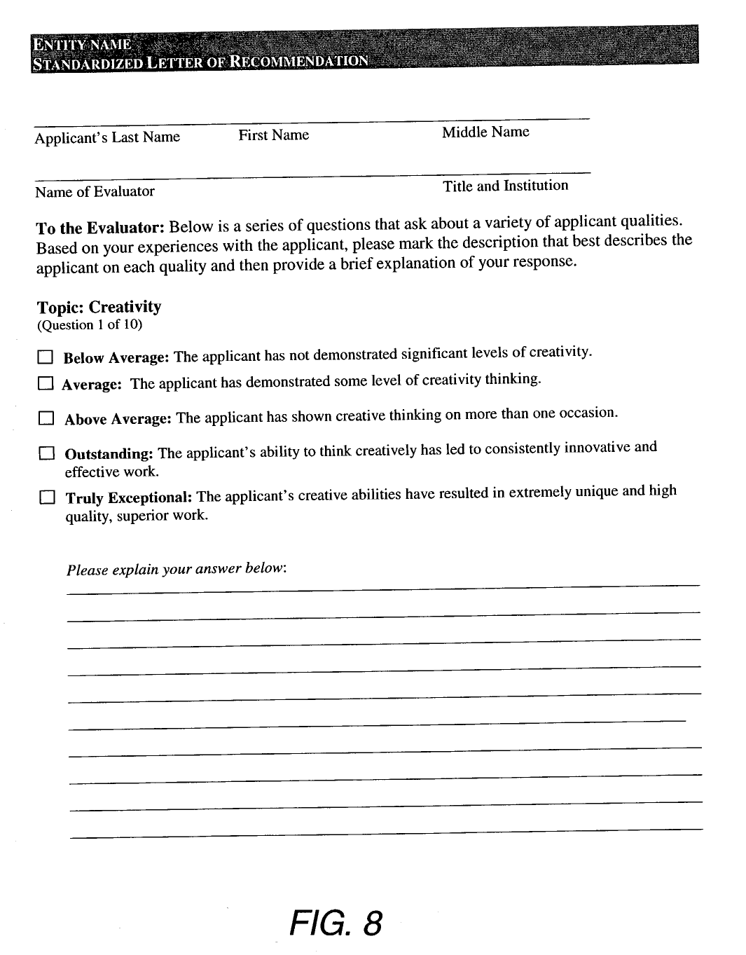

FIG. 8 is an example of a second embodiment of an applicant rating form. This rating form is identical to the rating form depicted in FIG. 4 with the exception that the evaluator would be required to provide an open-ended explanation for all ratings. This embodiment would include items that would inquire about additional constructs.

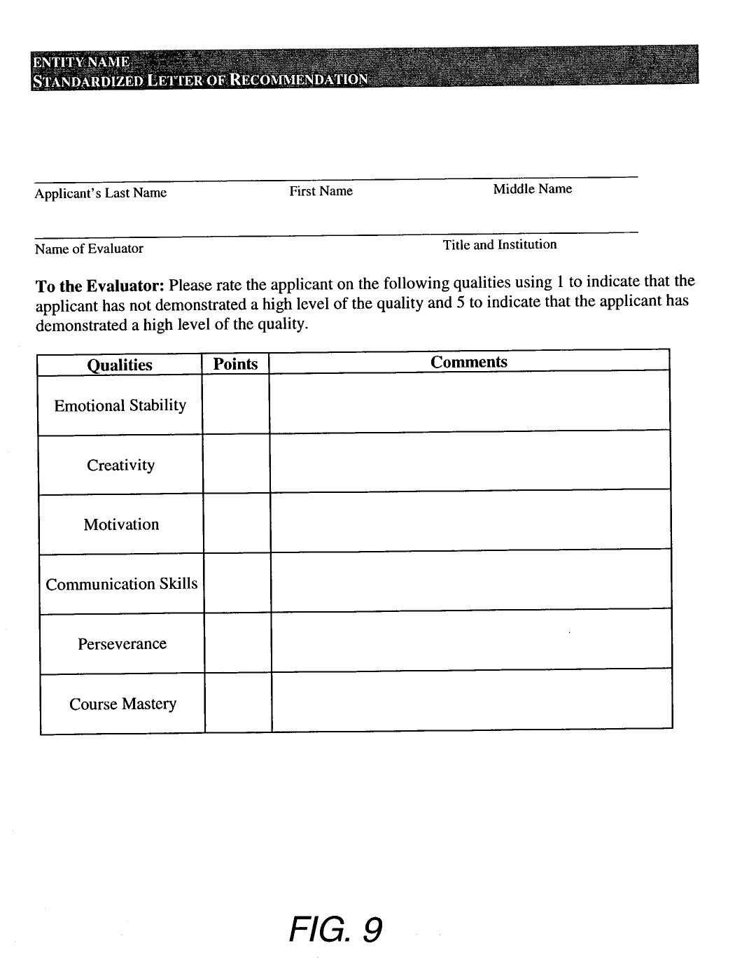

FIG. 9 is an example of a third embodiment of an applicant rating form that uses a point-system and open-ended format. Evaluators rate the applicant on a series of qualities on a scale of 1 to 5, and provide a brief explanation of the rating. This embodiment would include items that would inquire about additional constructs.

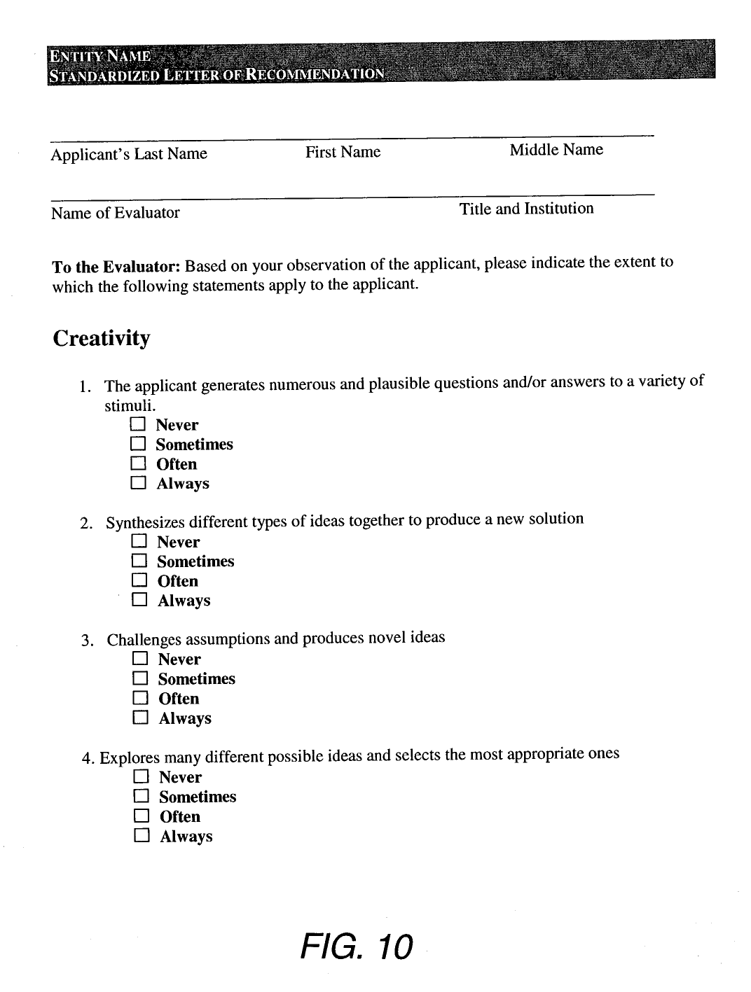

FIG. 10 is an example of a fourth embodiment of an applicant rating form using a behavioral observation format. In this embodiment, an evaluator indicates the frequency with which he or she has observed the behavior by the applicant. The evaluator responds to each statement using “never,” “sometimes,” “often,” or “always.” This embodiment would include items that would inquire about additional constructs.

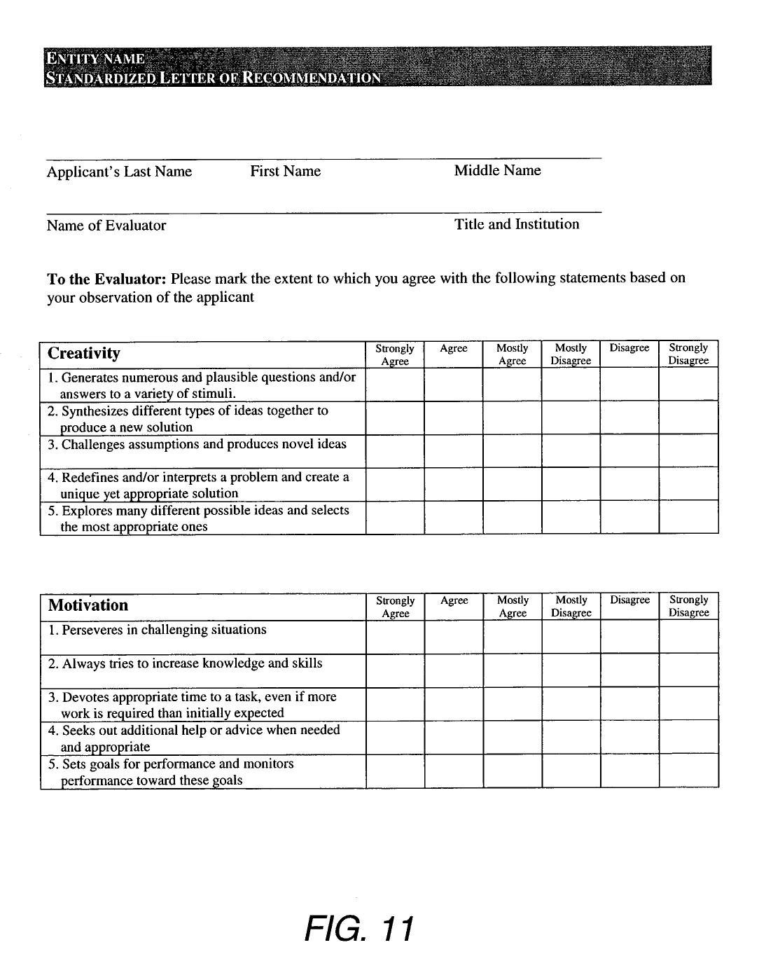

FIG. 11 is an example of a fifth embodiment of an applicant rating form. In this embodiment, an evaluator indicates the extent to which he or she agrees that each statement describes an applicant's behavior. The evaluator responds to each statement using “strongly agree,” “agree,” “mostly agree,” “disagree,” or “strongly disagree.” This embodiment would include items that would inquire about additional constructs.

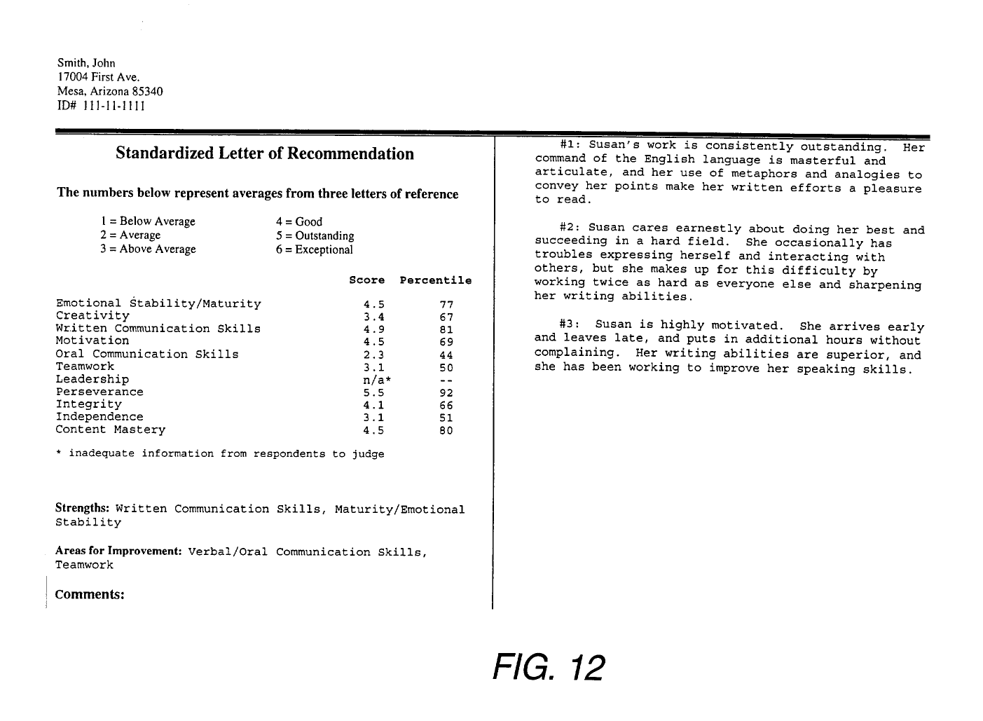

FIGS. 12-16 illustrate embodiments of output forms (e.g., reports) that may be generated for and transmitted to entities. FIG. 12 is an example of an output form in which the entity will receive scores and percentile rankings for each construct in addition to a summary of strengths and weaknesses. The entity will also receive verbatim open-ended comments by each evaluator.

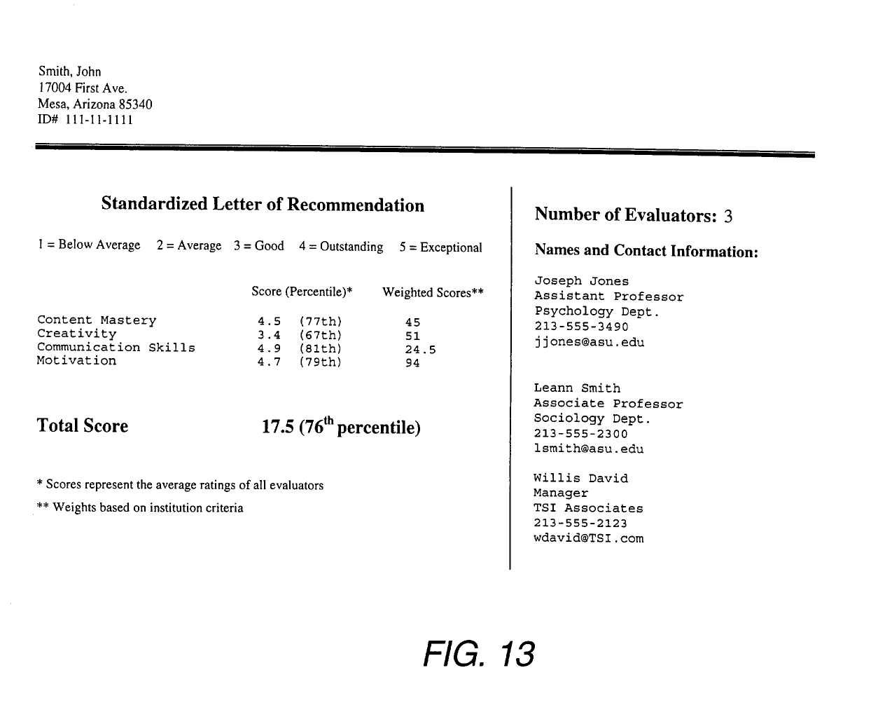

FIG. 13 is an example of a second embodiment of an output form for an entity. In this embodiment, the entity will receive the applicant's scores and percentile rankings on each construct. This form also provides weighted scores on each construct as determined by the relative importance of each construct to the entity. A total score is calculated from the construct score and is provided on the form. This form also provides the names and contact information of each evaluator.

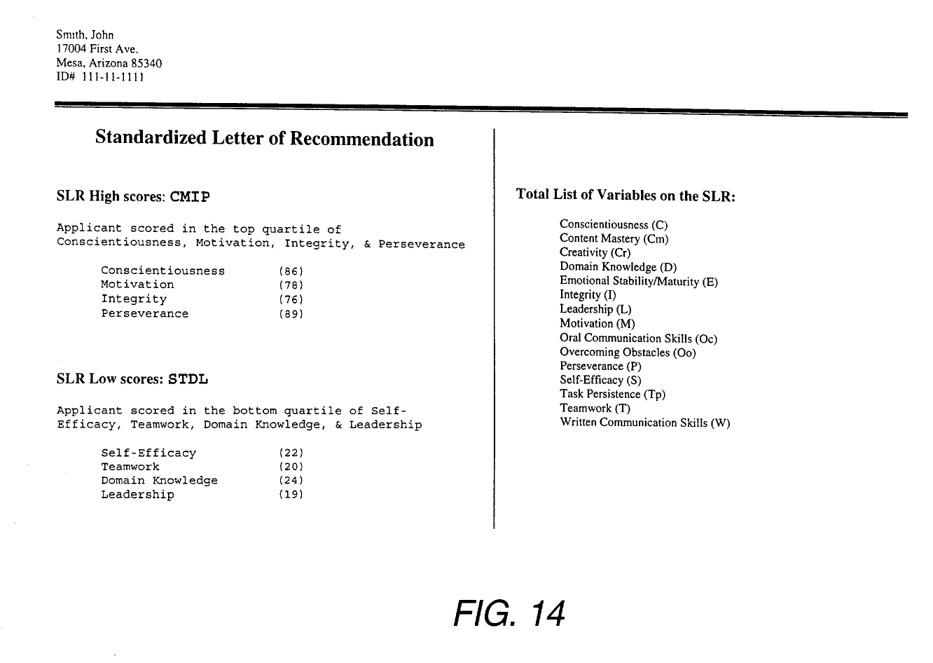

FIG. 14 is an example of a third embodiment of an output form for an entity. This form reports scores as a string of identifiers denoting the constructs on which the applicant receives the highest and the lowest ratings. The string of identifiers will be described further and will include the applicant's percentile ranking on each construct. This form would also include the total list of constructs from which the high and low scores were selected.

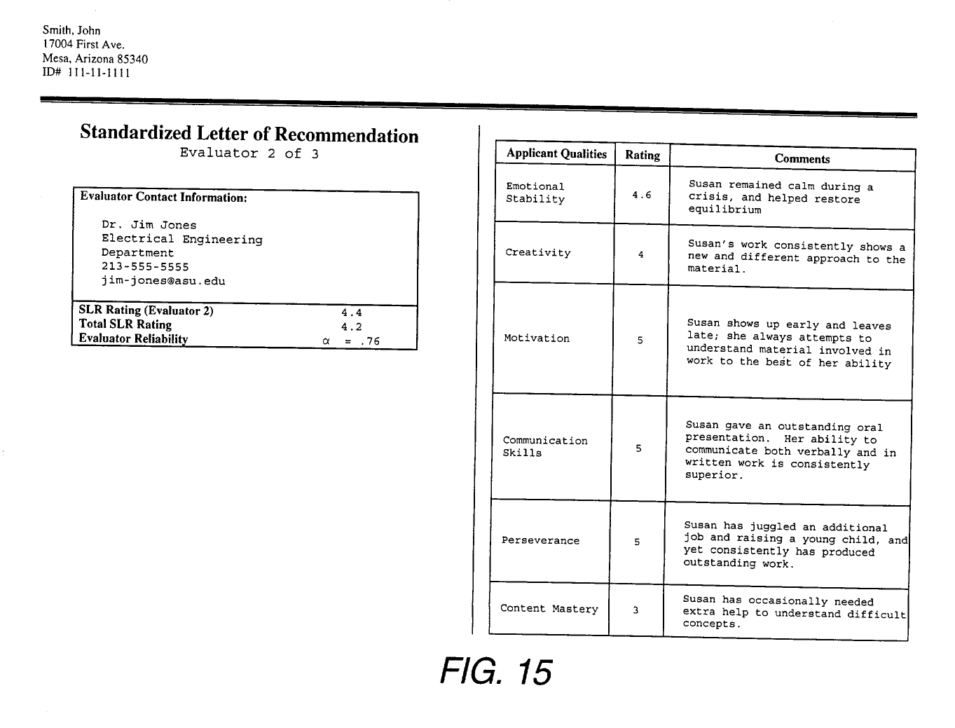

FIG. 15 is an example of a fourth embodiment of an output form for an entity. This form includes a numerical rating of the applicant on each construct followed by a verbatim, open-ended comment related to the construct. A version of this form would be received from each evaluator, rather than aggregating all of the evaluator data. Each form would include the evaluator contact information, the evaluator's average rating, and the average rating and reliability index across all evaluators. Additionally, an SLR rating and total SLR rating is calculated from construct values.

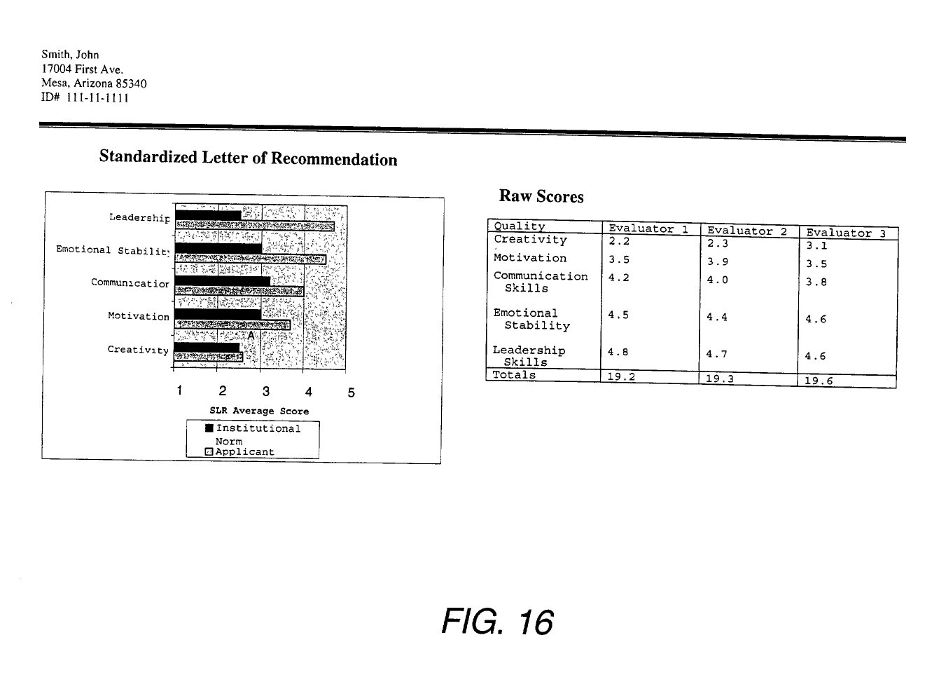

FIG. 16 is an example of a fifth embodiment of an output form for an entity. This form is an embodiment of a graphical applicant rating output form. The form illustrates one or more graphs comparing the applicant to the entity norm, or other applicants applying to the entity (not shown) or other applicants applying to the entity type (not shown). This form also provides raw scores for each construct for each evaluator.

The method for rating an applicant described may be compiled into computer programs. These computer programs can exist in a variety of forms both active and inactive. For example, the computer program can exist as software comprised of program instructions or statements in source code, object code, executable code or other formats. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While this invention has been described in conjunction with the specific embodiments thereof, it is evident that many alternatives, modifications and variations will be apparent to those skilled in the art. Also, it will be apparent to one of ordinary skill that the method for rating applicants may be used with services, which may not necessarily communicate over the Internet, but communicate with other entities through private networks and/or the Internet. These changes and others may be made without departing from the spirit and scope of the invention.

While the foregoing description includes many details and specificities, it is to be understood that these have been included for purposes of explanation only, and are not to be interpreted as limitations of the invention. Those skilled in the art will recognize that many variations are possible within the spirit and scope of the present invention, which is intended to be defined by the following claims—and their equivalents—in which all terms are meant in their broadest reasonable sense unless otherwise indicated.

What is claimed is:

1. A method for evaluating an applicant for an entity, the method comprising steps of:
selecting an evaluation instrument for evaluating the applicant based on an entity type, the evaluation instrument being used to solicit feedback from at least one evaluator;
receiving the evaluation instrument completed by the at least one evaluator; and
evaluating the applicant based on evaluator feedback in the completed, evaluation instrument.

2. The method of claim 1, wherein prior to the step of selecting the method further comprises a step of receiving a request to evaluate the applicant.

3. The method of claim 1, wherein the step of receiving the evaluation instrument comprises steps of:
requesting the at least one evaluator to complete the evaluation instrument; and
in response to the step of requesting, receiving the evaluation instrument completed by the at least one evaluator.

4. The method of claim 1, wherein the feedback solicited by the evaluation instrument comprises one or more of quantifiable responses and open-ended feedback from the at least one evaluator.

5. The method of claim 4, wherein the evaluation instrument includes quantifiable response options for soliciting the quantifiable responses, the quantifiable response options including statements associated with non-cognitive qualities.

6. The method of claim 5, wherein the non-cognitive qualities include at least one of emotional stability, maturity, creativity, motivation, teamwork, integrity, persistence, perseverance, oral and written communications skills, independence, content knowledge, course mastery, ability to overcome obstacles, conscientiousness, leadership, and overall fitness of the applicant with the entity.

7. The method of claim 1, further comprising generating a plurality of evaluation instruments for a plurality of entity types, the plurality of evaluation instruments including the evaluation instrument.

8. The method of claim 7, wherein the step of selecting further comprises selecting the evaluation instrument from the plurality of evaluation instruments based on the entity type for the entity the applicant is being evaluated for.

9. The method of claim 7, wherein the step of generating further comprises customizing the evaluation instrument based on specifications provided by the entity.

10. The method of claim 7, wherein the step of generating further comprises customizing the plurality of evaluation instruments for each entity type based on qualities associated with entities for each respective entity type.

11. The method of claim 7, wherein the step of generating further comprises generating one or more of the plurality of evaluation instruments using empirical research.

12. The method of claim 1, wherein the entity type comprises one or more of learning institution, business, and government.

13. The method of claim 1, wherein the step of evaluating further comprises assigning a score for the applicant based on the evaluator feedback.

14. The method of claim 13, further comprising transmitting the score to the entity.

15. The method of claim 13, further comprising steps of:
presenting aggregated scores of one or more other applicants for purposes of relative comparison by the entity.

16. The method of claim 15, further comprising a step of ranking applicants based on their corresponding scores.

17. The method of claim 13, wherein the step of assigning the score further comprises assigning a set of scores for each construct used for evaluating the applicant.

18. The method of claim 17, further comprising adding the set of scores to generate an overall score for the applicant.

19. The method of claim 13, further comprising accumulating a plurality of predetermined evaluation materials for the applicant in an applicant package, the applicant package including the score.

20. The method of claim 19, wherein the applicant package is based on specifications provided by the entity.

21. The method of claim 20, further comprising transmitting the applicant package to the entity.

22. The method of claim 13, further comprising:
summarizing the completed evaluation instrument for the applicant; and
assigning the score based on the summary.

23. The method of claim 1, wherein the evaluation instrument includes at least one form customized for the entity the applicant is being evaluated for.

24. A system for evaluating an applicant, the system comprising:
a host connected to a data storage device configured to store a plurality of evaluation instruments;
an applicant client connected to the host, the applicant client being configured to transmit a request to evaluate an applicant to the host;
at least one evaluator client connected to the host, the evaluator client being configured to receive an evaluation instrument of the plurality of evaluation instruments from the host and transmit at least one completed, evaluation instrument to the host; wherein
the host is configured to generate a report evaluating the applicant based on analysis of information from a completed, evaluation instrument transmitted from the at least one evaluator client.

25. The system of claim 24, further comprising an entity client connected to the host, the host being configured to transmit the report to the entity client.

26. The system of claim 25, wherein the entity client is associated with an entity and the applicant is being evaluated for the entity.

27. The system of claim 26, wherein the host is configured to select the evaluation instrument transmitted to the at least one evaluator client from the plurality of evaluation instruments based on an entity type of the entity.

28. The system of claim 25, wherein the host, the applicant client, the plurality of evaluator clients, and the entity client are connected through one or more networks.

29. The system of claim 28, wherein the one or more networks includes the Internet.

30. The system of claim 24, wherein the completed evaluation instrument comprises quantifiable responses.

31. The system of claim 30, wherein the host performs a statistical analysis on the quantifiable responses to evaluate the applicant.

32. The system of claim 31, wherein the host generates a numeric value for rating the applicant based on the statistical analysis.

33. The system of claim 32, wherein the host generates a numeric value for rating each of a plurality of applicants, such that the plurality of applicants are comparable to each other.

34. A method for generating an evaluation instrument for evaluating an applicant, the method comprising steps of:
identifying constructs for the evaluation instrument;
generating content for the evaluation instrument based on the identified constructs;
generating the evaluation instrument including the content, the content soliciting quantifiable responses and open-ended feedback from an evaluator.

35. The method of claim 34, further comprising steps of:
comparing quantifiable responses and open-ended feedback provided by a plurality of evaluators completing the evaluation instrument to evaluate the applicant; and
determining a reliability of the generated evaluation instrument based on the comparison.

36. The method of claim 35, wherein the step of comparing further comprises determining whether corresponding quantifiable responses on the plurality of completed evaluation instruments are in agreement.

37. The method of claim 36, further comprising modifying the content in the evaluation instrument in response to determining a substantial number of corresponding quantifiable responses disagree.

38. The method of claim 34, further comprising determining the validity of the evaluation instrument by analyzing a performance of a group of successful applicants.

39. The method of claim 34, wherein the evaluation instrument is a form for evaluating the applicant for an entity.

40. The method of claim 39, wherein feedback solicited by the evaluation instrument may be provided in the form by an evaluator.

41. A method for evaluating an applicant comprising steps of:
receiving at least one completed evaluation instrument having content for soliciting feedback to evaluate the applicant, the completed evaluation instrument including a plurality of quantifiable responses provided by an evaluator responding to the content in the evaluation instrument; and
assigning a numeric evaluation value for evaluating the applicant based on the plurality of quantifiable responses.

42. The method of claim 41, wherein the content is associated with a plurality of constructs and the step of assigning further comprises steps of:
determining a construct value for each construct based on the plurality of quantifiable responses; and
calculating the numeric evaluation value based on the construct values.

43. The method of claim 42, wherein the step of calculating further comprises averaging the construct values to calculate the numeric evaluation value.

44. The method of claim 42, wherein the step of calculating further comprises weighted averaging the construct values to calculate the numeric evaluation value, wherein construct values given more weight are specified by an entity for which the applicant is being evaluated.

45. The method of claim 41, further comprising receiving a confidence measure associated with at least one of the plurality of quantifiable responses, the confidence measure being used for assigning the numeric evaluation value.

46. The method of claim 41, further comprising generating a report including the assigned numeric evaluation value, the report being usable by an entity for which the applicant is being evaluated.

47. The method of claim 46, wherein the report comprises a numeric evaluation value for each of a plurality of applicants being evaluated for the entity.

48. The method of claim 47, wherein the report comprises a comparison of each of the plurality of applicants.

49. The method of claim 48, wherein the report comprises open-ended comments from each evaluator.

50. The method of claim 41, wherein the at least one completed evaluation instrument comprises a plurality of evaluation instruments.
